(19) United States
(12) Patent Application Publication
(10) Pub. No.: US 2025/0284134 A1
(43) Pub. Date: Sep. 11, 2025

(54) BEAM COMBINING DEVICE

(71) Applicant: Robert Bosch GmbH, Stuttgart (DE)

(72) Inventor: Ingo Ramsteiner, Ettlingen (DE)

(21) Appl. No.: 18/862,842

(22) PCT Filed: Oct. 13, 2023
(86) PCT No.: PCT/EP2023/078459

§ 371 Date: Nov. 4, 2024

(30) Foreign Application Priority Data
Dec. 6, 2022 (DE) 10 2022 213 136.3

(51) Int. Cl. G02B 27/10; G02B 5/32

(52) U.S. Cl. CPC G02B 27/1006; G02B 5/32

(57) ABSTRACT

A beam combining device having at least one single-piece monolithic body and a holographic optical element (HOE). The body has a flat top side and a flat bottom side opposite the top side. The body has a first and second curved outer side. The first outer side is curved such that first divergent light beams which have a first wavelength and radiate from the top side of the body and are incident on the first outer side are deflected in parallel in a first deflection angle in the direction of the bottom side of the body. The second outer side is curved such that second light beams which have a second wavelength and radiate from the top side of the body and are incident on the second outer side are deflected in parallel in a second deflection angle in the direction of the bottom side of the body.

### FIELD

The present invention relates to a beam combining device, to an optical system comprising the beam combining device, and to a method for producing the optical system.

### BACKGROUND INFORMATION

U.S. Patent Application Publication No. US 2022/0146754 A1 describes a coherent beam combining (CBC) device which is used to combine coherent light beams of the same wavelength to form a common light beam.

An object addressed by the present invention is to develop a beam combining device which also combines light beams of different wavelengths.

### SUMMARY

To achieve this object, a beam combining device having certain features of the present invention is provided. In addition, an optical system and a method for producing an optical system are provided.

According to an example embodiment of the present invention, the beam combining device has at least one single-piece, in particular monolithic, body, and a holographic optical element (HOE). The single-piece body has a top side, in particular a flat top side, and a bottom side, in particular a flat bottom side, opposite the top side. In addition, the single-piece body has at least one first and one second curved outer side. In particular, the first and second outer sides are directly adjacent to one another. The first outer side is designed to be curved such that first more particularly divergent light beams which have a first wavelength and radiate from the top side of the body and are incident on the first outer side are deflected in parallel in a first deflection angle in the direction of the bottom side of the body. The second outer side is designed to be curved such that more particularly divergent second light beams which have a second wavelength and radiate from the top side of the body and are incident on the second outer side are deflected in parallel in a second deflection angle in the direction of the bottom side of the body. The holographic optical element is at least indirectly connected to the bottom side of the body and is designed to deflect the first light beams incident on the holographic optical element in a first angle of incidence and the second light beams incident on the holographic optical element in a second angle of incidence, in particular in parallel, at a common exit angle. In particular, the holographic optical element in this connection is designed to deflect the incident first and second light beams such that the first and second light beams are combined to form a common light beam. The beam combining device described has the advantage that light beams of different wavelengths can be combined using only a single, single-piece body.

According to an example embodiment of the present invention, preferably, the single-piece body additionally has a third curved outer side, which is curved such that third more particularly divergent light beams which have a third wavelength and radiate from the top side of the body and are incident on the third outer side are deflected in parallel in a third deflection angle in the direction of the bottom side of the body. The holographic optical element additionally serves to deflect the third light beams incident on the holographic optical element at a third angle of incidence at the common exit angle. Preferably, the single-piece body has a total of three outer sides, which in particular directly adjoin one another. Preferably, the single-piece body is shaped as a truncated pyramid, in particular on a top side, with outwardly curved outer sides.

According to an example embodiment of the present invention, preferably, the outer sides of the single-piece body have the same radii of curvature. Alternatively, at least two outer sides of the single-piece body have different radii of curvature to one another.

According to an example embodiment of the present invention, preferably, the holographic optical element is designed as a multiplexing HOE. In this connection, the holographic optical element in particular has only a single layer with different volume holograms or different functions. In this case, the diffraction efficiencies are generally smaller than with a plurality of layers in each case having only a single volume hologram or a single function. Preferably, the holographic optical element has at least one first volume hologram having a first Bragg plane and one second volume hologram having a second Bragg plane. The first Bragg plane is perpendicular to the second Bragg plane. The first volume hologram is assigned to the light beams having the first wavelength and the second volume hologram is assigned to the light beams having the second wavelength. This means that, for example, there are no unwanted interference reflections within the multiplexing HOE. Alternatively, the holographic optical element is formed from a plurality of layers, wherein a first layer is designed to deflect the first light beams and a second layer is designed to deflect the second light beams at the common exit angle.

According to an example embodiment of the present invention, preferably, the holographic optical element is directly connected in a planar manner to the bottom side of the body. Alternatively, the holographic optical element is fastened to the bottom side of the holographic optical element by means of at least one adhesion promoter, in particular an adhesive. Further alternatively, the beam combining device additionally comprises a carrier substrate for the holographic optical element, which is connected in a planar manner to the bottom side of the body. An adhesion promoter can also be used to connect the carrier substrate to the bottom side of the single-piece body. Preferably, the holographic optical element completely covers the bottom side of the single-piece body or the carrier substrate.

According to an example embodiment of the present invention, preferably, the single-piece, in particular monolithic, body is transparent, in particular made of silicate glass or a polymer.

According to an example embodiment of the present invention, preferably, the outer sides of the body are designed as mirrors. Alternatively, the outer sides of the body are designed such that the light beams are deflected or reflected in the direction of the bottom side of the body by means of total reflection.

The present invention also relates to an optical system which comprises the beam combining device of the present invention described above. In addition, according to an example embodiment of the present invention, the optical system has a first light source, in particular a laser diode, for radiating more particularly divergent first light beams with a first wavelength into a top side of a single-piece, in particular monolithic, body of the beam combining device. Furthermore, the optical system has a second light source, in particular a laser diode, for radiating more particularly divergent second light beams with a second wavelength into the top side of the single-piece, in particular monolithic, body of the beam combining device. Preferably, the first light source is designed to radiate first light beams in a red wavelength range, and the second light source is designed to radiate second light beams in a green wavelength range, into the top side of the body. Further preferably, the optical system comprises a third light source, in particular a laser diode, for radiating more particularly divergent light beams third light beams with a third wavelength into the top side of the single-piece, in particular monolithic, body of the beam combining device. Preferably, the third light source is designed to radiate third light beams in a blue wavelength range into the top side of the body.

According to an example embodiment of the present invention, preferably, a first outer side of the single-piece body is designed to deflect the first light beams that radiate from the top side of the body, are incident on the first outer side and are more particularly divergent light beams in a first deflection angle such that the first light beams are incident on the holographic optical element in a first angle of incidence of substantially 70.5° relative to a surface normal of the holographic optical element. Furthermore, a second outer side of the single-piece body is designed to deflect the second light beams that radiate from the top side of the body, are incident on the second outer side and are more particularly divergent light beams in a second deflection angle such that the second light beams are incident on the holographic optical element in a second angle of incidence of substantially 70.5° relative to the surface normal of the holographic optical element. The advantage of these angles of incidence is that the Bragg planes of the volume holograms are perpendicular to one another according to Bragg's law.

According to an example embodiment of the present invention, preferably, the light sources are arranged on the top side of the single-piece body. In particular, the light sources are at least indirectly connected to the top side of the single-piece body. Preferably, the light sources are connected directly or by means of a coupling material to the top side of the single-piece body. This eliminates Fresnel losses, which can occur due to an air gap between the light source and the top side of the body.

The present invention also relates to a method for producing an optical system. According to an example embodiment of the present invention, in one method step, a first light source, in particular a first laser diode, for generating more particularly divergent first light beams having a first wavelength is attached to a carrier substrate of the first light source, in particular to a circuit board of the first light source. Furthermore, a first optical arrangement having a first relay lens is arranged relative to the first light source such that first object beams and first reference beams are generated from the first light beams generated. Furthermore, a single-piece, in particular monolithic, body is arranged relative to the first optical arrangement such that the first reference beams radiate in an in particular flat top side of the body and are deflected in a parallelized manner on a first curved outer side of the body in the direction of an in particular flat bottom side of the body such that the first reference beams are superimposed with the first object beams, which also radiate via the top side of the body, on a holographic exposure material arranged on the bottom side of the body. The first relay lens in the first optical arrangement serves in particular to focus the divergent first reference beams generated by means of a first beam splitter of the first optical arrangement at a first point of incidence in the top side of the single-piece body as the first focal point. Thus, this first point of incidence of the first reference beams in the top side of the single-piece body is optimally determined for the subsequent installation location of the first light source on the top side of the single-piece body. In a further method step, a second light source, in particular a second laser diode, for generating more particularly divergent second light beams having a second wavelength is attached to the carrier substrate of the first and second light sources, in particular to the circuit board of the first and second light sources. Furthermore, a second optical arrangement having a second relay lens is arranged relative to the second light source such that second object beams and second reference beams are generated from the second light beams generated. In addition, the single-piece, in particular monolithic, body is arranged relative to the second optical arrangement such that the second reference beams radiate in the top side of the body and are deflected on a second curved outer side of the body in a parallelized manner in the direction of the bottom side of the body such that the second reference beams are superimposed with the second object beams, which also radiate via the top side of the body, on the holographic exposure material. Here as well, the second relay lens serves to focus the divergent second reference beams generated by means of a second beam splitter of the second optical arrangement at a second point of incidence in the top side of the single-piece body as a second focal point. Thus, this second point of incidence of the second reference beams in the top side of the single-piece body is optimally determined for the subsequent installation location of the second light source on the top side of the single-piece body. The first and/or second optical arrangement arranged between the single-piece body and the first and second light sources oriented in the direction of the top side of the single-piece body is then removed. Furthermore, the carrier substrate together with the first and second light sources is displaced relative to the top side of the body, in particular in parallel therewith. Thus, the first and second light sources are displaced to exactly the location on the top side of the body at which the first and second reference beams were previously radiated into the top side and focused as focal points by means of the corresponding relay lenses. In a further method step, the first and second light sources are attached or fastened together with the carrier substrate to the top side of the single-piece body.

### BRIEF DESCRIPTION OF THE DRAWINGS

FIG. 1A shows a three-dimensional view of an optical system comprising a beam combining device, according to an example embodiment of the present invention.

FIG. 1B shows a sectional view of the optical system comprising the beam combining device, according to an example embodiment of the present invention.

FIG. 2 shows a schematic view of the deflection of a first and a second light beam incident on a holographic optical element, according to an example embodiment of the present invention.

FIG. 3 schematically shows a method for producing an optical system, according to an example embodiment of the present invention.

### DETAILED DESCRIPTION OF EXAMPLE EMBODIMENTS

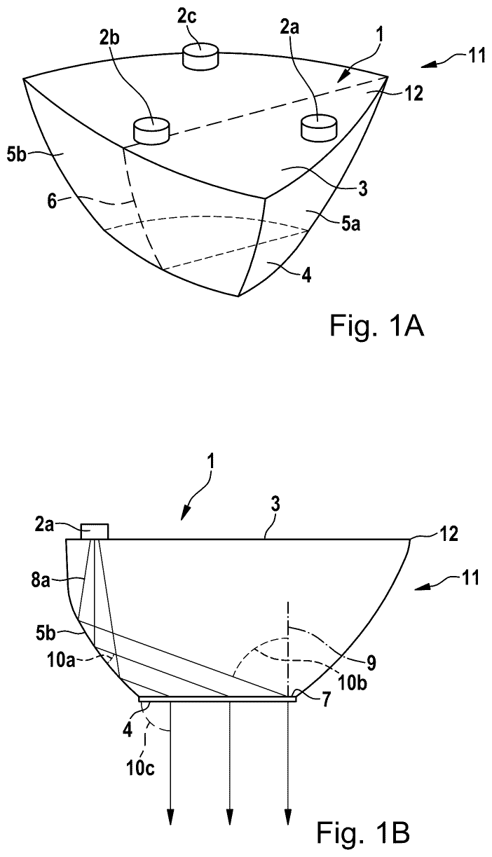

FIGS. 1A and 1B are schematic three-dimensional views of an optical system 1 which has a beam combining device 11. The beam combining device 11 has a single-piece, in particular monolithic, body 12 and a holographic optical element (HOE) 4. The single-piece body 12 in turn has a flat top side 3 and a flat bottom side 7 opposite the top side. In addition, the single-piece body 12 has a first curved outer side 5a and a second curved outer side 5b. As FIG. 1B shows by means of a sectional view along the cutting plane 6, the second outer side 5b is curved such that divergent second light beams 8a with a second wavelength that radiate from the top side 3 of the body 12 and are incident on the second outer side 5b are deflected in parallel in a second deflection angle 10a in the direction of the bottom side 7 of the body 12. The same applies to the first outer side 5a, which is curved such that divergent first light beams with a first wavelength that radiate from the top side 3 of the body 12 and are incident on the first outer side 5a are deflected in parallel in a first deflection angle in the direction of the bottom side 7 of the body 12. In this embodiment, the holographic optical element 4 is directly connected in a planar manner to the bottom side 7 of the body 12 and is designed to deflect the first light beams incident on the holographic optical element 7 in a first angle of incidence and the second light beams 8a incident on the holographic optical element 4 in a second angle of incidence 10b in parallel at a common exit angle 10c. In this case, the first and second light beams 8a exit the beam combining device 11 perpendicularly to a main extension plane of the holographic optical element 4. Alternatively, the beam combining device 11 additionally has a carrier substrate for the holographic optical element 4, which is connected in a planar manner, in particular directly, to the bottom side 7 of the body 12. Furthermore, the optical system 1 has a first laser diode as a first light source 2a for radiating the first light beams having a first wavelength into the top side 3 of the single-piece body 12 of the beam combining device 11. In addition, the optical system 11 has a second laser diode as a second light source 2b for radiating the divergent second light beams 8a having the second wavelength into the top side 3 of the single-piece body 12 of the beam combining device 11. The light sources 2a, 2b and 2c are arranged on the top side 3 of the single-piece body 12 in FIG. 1A and 1B. The light sources 2a, 2b and 2c are connected to the top side of the single-piece body 12 by means of a joining material, in particular using an adhesion promoter.

In this embodiment, the single-piece body 12 of the beam combining device 11 additionally has a third curved outer side (not visible in FIG. 1B). This third outer side is curved such that divergent third light beams having a third wavelength that are radiated in from the top side 3 of the body 12 by means of a third laser diode as the third light source 2c and are incident on the third outer side are deflected in parallel in a third deflection angle in the direction of the bottom side 7 of the body 12. The holographic optical element 4 is in turn designed to deflect the third light beams incident on the holographic optical element 4 in a third angle of incidence at the common exit angle 10c. The outer sides 5a, 5b and 5c of the single-piece body 12 have the same radii of curvature.

The holographic optical element 4 is designed as a multiplexing HOE. This means that the holographic optical element 4 in this embodiment is formed from only a single layer having different deflection functions.

In this embodiment, the single-piece body 12 is transparent, in particular made of silicate glass or a polymer. Furthermore, the outer sides 5a, 5b and 5c of the single-piece body 12 are designed such that the light beams 8a are deflected in the direction of the bottom side 7 of the body 12 by means of total reflection. Alternatively, the outer sides 5a, 5b and 5c of the body 12 can also be designed as mirrors.

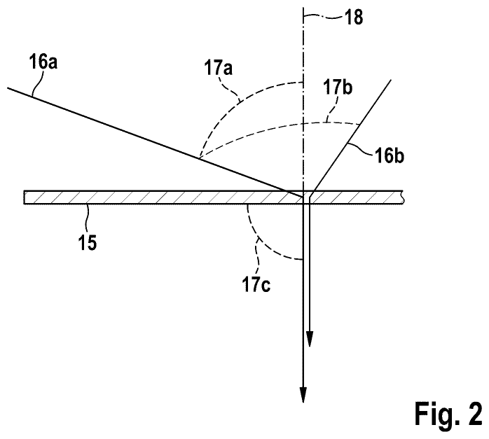

FIG. 2 is a schematic side view of a holographic optical element 15 of an optical system (not shown in more detail here), as shown by way of example in FIG. 1A and 1B. Here as well, the holographic optical element 15 is designed as a multiplexing HOE and is designed to deflect the first light beams 16a incident on the holographic optical element 15 in a first angle of incidence 17a and the second light beams 17b incident on the holographic optical element 15 in a second angle of incidence 17b at a common exit angle 17c. In this case, the first light beams 16a are designed as first light beams in a red wavelength range and the second light beams 16b are designed as second light beams in a green wavelength range and the holographic optical element 15 serves to join or combine the two light beams 16a and 16b upon exit.

A first outer side of the single-piece body of the beam combining device (not shown here) is designed to deflect the first more particularly divergent light beams 16a, which radiate from the top side of the body (likewise not shown here) and are incident on the first outer side in a first deflection angle such that the first light beams are incident on the holographic optical element 15 in the first angle of incidence 17a of substantially 70.5° relative to a surface normal 18 of the holographic optical element 15. A second outer side of the single-piece body of the beam combining device (likewise not shown here) is designed to deflect the second more particularly divergent light beams 16b which radiate from the top side of the body and are incident on the first outer side in a second deflection angle such that the second light beams 16b are incident on the holographic optical element in a second angle of incidence 17b, wherein the second light beams 16b also have an angle of 70.5° to the HOE normal and an angle of 120° to the first light beams when being projected onto the HOE (azimuth relative to the bottom side). In this case, the holographic optical element 15 has a first volume hologram having a first Bragg plane and a second volume hologram having a second Bragg plane. The first Bragg plane is perpendicular to the second Bragg plane and the first volume hologram deflects the first light beams 16a of the first wavelength and the second volume hologram deflects the second light beams 16b of the second wavelength. For example, there are fewer interference reflections within the multiplexing HOE.

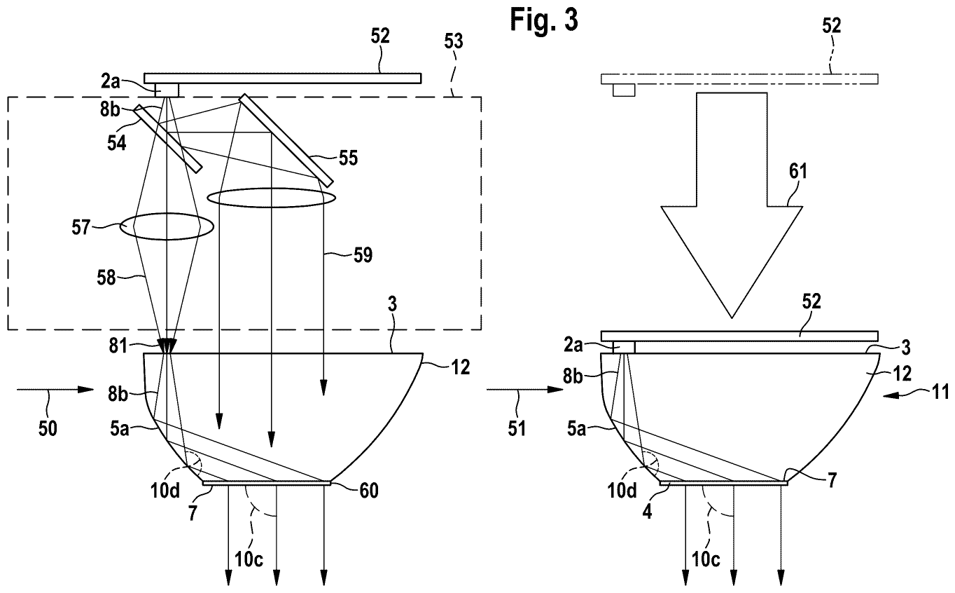

FIG. 3 schematically shows steps of a method for producing an optical system 80. First, the first light source 2a for generating divergent, first light beams 8b having a first wavelength is attached to a carrier substrate 52 of the first light source 2a. The carrier substrate is a circuit board of the first light source 2a. Furthermore, a first optical arrangement 53 having a first relay lens 57 is arranged relative to the first light source 2a such that first object beams 58 and first reference beams 59 are generated from the first light beams 8b generated. Furthermore, the single-piece body 12 is arranged relative to the first optical arrangement 53 and the first light source 2a. The relay lens 57 in the first optical arrangement 53 serves to focus the divergent first reference beams 58 transmitted by a first beam splitter 54 of the first optical arrangement 53 at a first point of incidence in the top side 3 of the single-piece body 12 as a first focal point 81. Furthermore, the first optical arrangement 53 has a mirror for deflecting the object beams 53 in the direction of the holographic exposure material 60 arranged on the bottom side 7 of the body 12. In this method step 50, the single-piece body 12 is arranged relative to the first optical arrangement 53 such that the first reference beams 58 radiate the top side 3 of the body 12 and are deflected in a parallelized manner on the first curved outer side 5a of the body in the direction of the bottom side 7 of the body such that the first reference beams 58 are superimposed with the first object beams 59, which also radiate via the top side 3 of the body 12, on the holographic exposure material 60 arranged on the bottom side 7 of the body 12. In a further method step (not shown here for the sake of simplicity), the second light source 2b for generating divergent, second light beams having a second wavelength is attached to the carrier substrate 52 of the first 2a and second 2b light source. A second optical arrangement (likewise not shown here), having a second relay lens is then arranged relative to the second light source 2b such that second object beams and second reference beams are generated from the second light beams generated. In addition, the single-piece body 12 is arranged relative to the second optical arrangement such that the second reference beams radiate the top side 3 of the body 12 and are deflected at the second curved outer side 5b of the body 12 in the direction of the bottom side 4 of the body in a parallelized manner in a first deflection angle 10d such that the second reference beams are superimposed with the second object beams, which also radiate via the top side of the body, at the holographic exposure material 60. In principle, the method steps shown for the first light source 2a in FIG. 3 are repeated for the second light source 2b with a different second optical arrangement. The method steps described above can in principle also be carried out for other light sources, in particular the third light source 2c. In a further method step, the second optical arrangement arranged between the single-piece body 12 and the first 2a and second 2b light sources oriented in the direction of the top side 3 of the single-piece body 12 is removed. In a further method step 51, the carrier substrate 52 together with the first light source 2a and the second light source 2b is displaced in parallel 61 with the top side 3 of the body. The first light source 2a and the second light source 2b are then attached together with the carrier substrate 52 to the top side 3 of the single-piece body 12.

1-15. (canceled)

16. A beam combining device, comprising:
a single-piece monolithic body; and
a holographic optical element;
wherein the single-piece body has a flat top side and a flat bottom side opposite the top side, and at least one first and one second curved outer side, wherein the first outer side is curved such that first divergent light beams which have a first wavelength and radiate from the top side of the single-piece body and are incident on the first outer side are deflected in parallel in a first deflection angle in a direction of the bottom side of the single-piece body, wherein the second outer side is curved such that divergent second light beams which have a second wavelength and radiate from the top side of the single-piece body and are incident on the second outer side are deflected in parallel in a second deflection angle in the direction of the bottom side of the single-piece body;
wherein the holographic optical element is at least indirectly connected to the bottom side of the single-piece body and is configured to deflect the first light beams incident on the holographic optical element in a first angle of incidence and the second light beams incident on the holographic optical element in a second angle of incidence, in parallel, at a common exit angle.

17. The beam combining device according to claim 16, wherein:
the single-piece body additionally has a third curved outer side, wherein the third outer side is curved such that third divergent light beams which have a third wavelength and radiate from the top side of the single-piece body and are incident on the third outer side are deflected in parallel in a third deflection angle in the direction of the bottom side of the single-piece body, and
the holographic optical element is additionally configured to deflect the third light beams incident on the holographic optical element in a third angle of incidence at the common exit angle.

18. The beam combining device according to claim 16, wherein the first and second outer sides of the single-piece body have equal radii of curvature.

19. The beam combining device according to claim 16, wherein the holographic optical element is a multiplexing holographic optical element.

20. The beam combining device according to claim 19, wherein the holographic optical element has at least one first volume hologram with a first Bragg plane and one second volume hologram with a second Bragg plane, wherein the first Bragg plane is perpendicular to the second Bragg plane, and the first volume hologram is assigned to the first light beams having the first wavelength and the second volume hologram is assigned to the second light beams having the second wavelength.

21. The beam combining device according to claim 16, wherein the holographic optical element is directly connected in a planar manner to the bottom side of the single-piece body.

22. The beam combining device according to claim 16, wherein the beam combining device additionally has a carrier substrate for the holographic optical element, wherein the carrier substrate is directly connected in a planar manner to the bottom side of the single-piece body.

23. The beam combining device according to claim 16, wherein the single-piece body is transparent and is made of silicate glass or a polymer.

24. The beam combining device according to claim 16, wherein the first and second outer sides of the single-piece body are mirrors.

25. The beam combining device according to claim 16, wherein the first and second outer sides of the one-piece body are configured such that the first and second light beams are deflected in the direction of the bottom side of the single-piece body by total reflection.

26. An optical system, comprising:
a beam combining device;
a first light source including a laser diode, configured to radiate divergent first light beams with a first wavelength into a top side of a single-piece monolithic body of the beam combining device; and
a second light source including a laser diode, configured to radiate divergent second light beams with a second wavelength into the top side of the single-piece monolithic body of the beam combining device;
wherein the beam combining device includes:
the single-piece monolithic body, and
a holographic optical element,
wherein the top side of the single-piece body is flat, and wherein the single-piece body has a flat bottom side opposite the top side, and at least one first and one second curved outer side, wherein the first outer side is curved such that the first divergent light beams which have the first wavelength and radiate from the top side of the single-piece body and are incident on the first outer side are deflected in parallel in a first deflection angle in a direction of the bottom side of the single-piece body, wherein the second outer side is curved such that the divergent second light beams which have a second wavelength and radiate from the top side of the single-piece body and are incident on the second outer side are deflected in parallel in a second deflection angle in the direction of the bottom side of the single-piece body;
wherein the holographic optical element is at least indirectly connected to the bottom side of the single-piece body and is configured to deflect the first light beams incident on the holographic optical element in a first angle of incidence and the second light beams incident on the holographic optical element in a second angle of incidence, in parallel, at a common exit angle.

27. The optical system according to claim 26, wherein the first light source is configured to radiate the first light beams in a red wavelength range, and the second light source is configured to the second light beams in a green wavelength range, into the top side of the single-piece body.

28. The optical system according to claim 26, wherein a first outer side of the single-piece body is configured to deflect the first divergent light beams which radiate from the top side of the single-piece body and are incident on the first outer side in a first deflection angle such that the first light beams are incident on the holographic optical element in a first angle of incidence of substantially 70.5° relative to a surface normal of the holographic optical element, and wherein a second outer side of the single-piece body is configured to deflect the divergent second light beams which radiate from the top side of the single-piece body and are incident on the second outer side in a second deflection angle such that the second light beams are incident on the holographic optical element in a second angle of incidence of substantially 70.5°.

29. The optical system according to claim 28, wherein the first and second light sources are arranged on the top side of the single-piece body, and are at least indirectly connected to the top side of the single-piece body.

30. A method for producing an optical system, comprising the following steps:
attaching a first light source including a first laser diode, configured to generate divergent first light beams with a first wavelength to a carrier substrate of the first light source, the carrier substrate including a circuit board of the first light source;
arranging a first optical arrangement having a first relay lens relative to the first light source such that first object beams and first reference beams are generated from the generated first light beams;
arranging a single-piece monolithic, body relative to the first optical arrangement such that the first reference beams radiate in a flat top side of the single-piece body and are deflected on a first curved outer side of the single-piece body in a parallelized manner in a direction of a flat bottom side of the single-piece body such that the first reference beams are superimposed with the first object beams, which also radiate via the top side of the single-piece body, on a holographic exposure material arranged on the bottom side of the single-piece body;
attaching a second light source including a second laser diode, configured to generate divergent second light beams with a second wavelength to the carrier substrate;
arranging a second optical arrangement with a second relay lens relative to the second light source such that second object beams and second reference beams are generated from the generated second light beams;
arranging the single-piece monolithic body relative to the second optical arrangement such that the second reference beams radiate in the top side of the single-piece body and are deflected in a parallelized manner on a second curved outer side of the single-piece body in the direction of the bottom side of the single-piece body such that the second reference beams are superimposed with the second object beams, which also radiate via the top side of the single-piece body, on the holographic exposure material;
removing the first and/or second optical arrangement arranged between the single-piece body and the first and second light source oriented in the direction of the top side of the single-piece body;
displacing the carrier substrate together with the first and second light source relative to the top side of the single-piece body, in parallel with the top side of the single-piece; and
attaching the first and second light sources together with the carrier substrate to the top side of the single-piece body.
